(19) United States
(12) Patent Application Publication
(10) Pub. No.: US 2025/0036037 A1
(43) Pub. Date: Jan. 30, 2025

(54) ELECTROSTATIC CHARGE IMAGE DEVELOPING TONER, IMAGE FORMING METHOD, AND IMAGE FORMING APPARATUS

(71) Applicant: Konica Minolta, Inc., Tokyo (JP)

(72) Inventors: Shiori TSUDA, Tokyo (JP); Atsushi IIOKA, Kanagawa (JP); Kazuya ISOBE, Tokyo (JP); Yukiko NAKAI, Kanagawa (JP); Genki WATANABE, Tokyo (JP)

(21) Appl. No.: 18/776,488

(22) Filed: Jul. 18, 2024

(30) Foreign Application Priority Data
Jul. 24, 2023 (JP) 2023-119913

(51) Int. Cl. G03G 9/087; G03G 9/08; G03G 15/20

(52) U.S. Cl. CPC G03G 9/08728; G03G 9/0804; G03G 15/2064; G03G 2215/0604

(57) ABSTRACT

A toner for developing an electrostatic charge image, the toner including a binder resin in a toner base particle, in which the binder resin includes a polymer having a constituent unit represented by the following general formula (1) and a constituent unit represented by the following general formula (2):

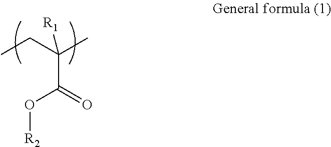

where, R₁ represents a hydrogen atom or a methyl group, and R₂ represents a hydrocarbon group having 6 or more and 12 or less carbon atoms and having an alicyclic structure, and

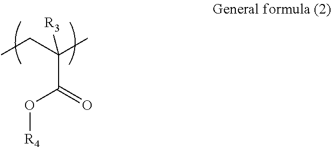

where, R₃ represents a hydrogen atom or a methyl group, and R₄ represents a linear or branched hydrocarbon group having 8 or more and 18 or less carbon atoms.

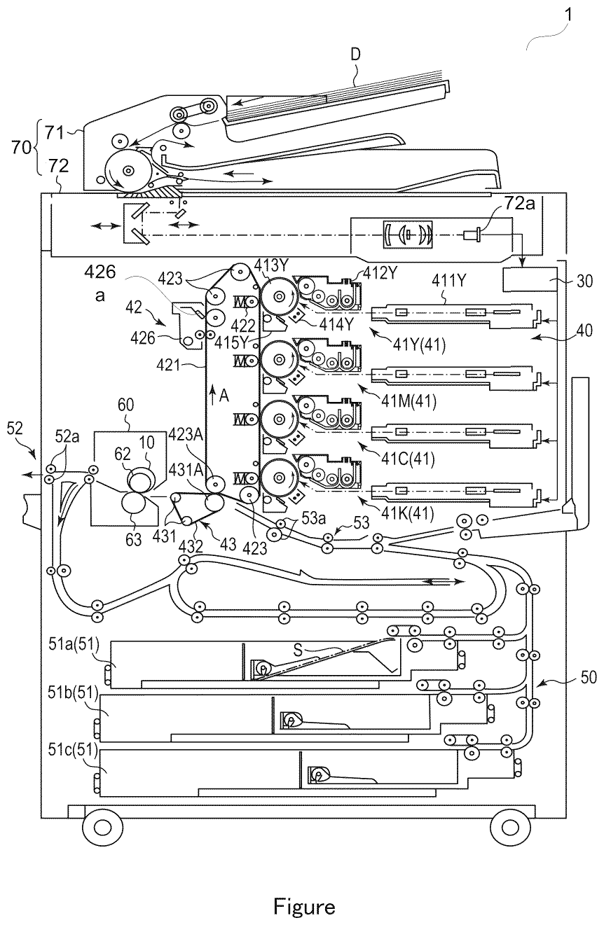

### CROSS REFERENCE TO RELATED APPLICATIONS

The entire disclosure of Japanese Patent Application No. 2023-119913 filed on Jul. 24, 2023, is incorporated herein by reference in its entirety.

### BACKGROUND

### Technological Field

The present invention relates to a toner for developing an electrostatic charge image (herein also simply referred to as “electrostatic charge image developing toner”), an image forming method, and an image forming apparatus.

### Description of Related Art

An image formed with the electrostatic charge image developing toner is fixed onto a recording medium, and then the recording medium is conveyed while being in contact with many conveyance rollers and ejected. At this time, the output image may be charged by contact with the conveyance roller or contact with another member included in the image forming apparatus. Charging of the image causes electrostatic adhesion between the image and another recording medium. The above-described image adhesion may become an obstacle in post-processing such as varnishing and laminating, or may cause generation of a defective product on which such post-processing is not performed.

In particular, when the printing speed is increased, the image tends to be discharged from the image forming apparatus before the charged electric charge leaks, and the problem due to the charging of the image tends to significantly occur. In addition, when an image is formed on a recording medium having a high insulating property, such as a resin film or stone paper, the problem due to the charging of the image is more likely to occur significantly.

Japanese Unexamined Patent Publication No. 2000-089508 teaches that a toner using a resin obtained by copolymerizing a (meth)acrylic monomer having a cyclic structure have small changes in chargeability due to moisture in the air because of low polarity of the resins.

Note that in order to increase the speed of image formation, the toner is required to have improved low-temperature fixability. Japanese Unexamined Patent Publication No. 2014-130243 teaches that a toner using a resin obtained by copolymerizing a (meth)acrylic monomer having a long-chain alkyl group is excellent in low-temperature fixability because its side chain (long-chain alkyl group) is more likely to crystallize.

The resin described in Japanese Unexamined Patent Publication No. 2000-089508 has an alicyclic structure with a low polarity. Therefore, it is expected that use of a toner containing such a resin can form an image that is less likely to be charged due to contact with conveyance rollers and the like and is less likely to cause the above-described problem due to charging. However, according to the finding by the present inventors, a resin having an alicyclic structure has low elastic properties because polymer chains are less likely to be entangled with each other due to the bulky alicyclic structure. Therefore, a toner containing such a resin tends to cause hot offset. In addition, a resin having an alicyclic structure generally has a high glass transition temperature. Therefore, a toner containing such a resin does not have high low-temperature fixability.

On the other hand, the resins having long-chain alkyl groups described in Japanese Unexamined Patent Publication No. 2014-130243 can increase the low-temperature fixability of the toner. However, a resin having a long-chain alkyl group has low polarity, is easily crystallized and has small molecular momentum, and therefore has a low dielectric loss tangent (tan δ). Therefore, a toner containing such a resin is more likely to cause image charging due to contact with a conveyance roller or the like. In addition, a resin having a long-chain alkyl group has low elastic properties because the resin is easily crystallized and polymer chains are less likely to be entangled with each other. Therefore, a toner containing such a resin tends to cause hot offset.

### SUMMARY

The present invention has been made in consideration of the above-described problems. The present invention provides an electrostatic charge image developing toner that can form an image that is less likely to cause adhesion due to charging that would be caused by contact with components of an image forming apparatus, has high low-temperature fixability, and is less likely to cause hot offset. The present invention provides an image forming method using the electrostatic charge image developing toner, and an image forming apparatus for forming an image using the electrostatic charge image developing toner.

In order to achieve at least one of the objects described above, a toner for developing an electrostatic charge image reflecting an aspect of the present invention includes a binder resin in toner base particles of the toner, and the binder resin includes a polymer having a constituent unit represented by the following general formula (1) and a constituent unit represented by the following general formula (2).

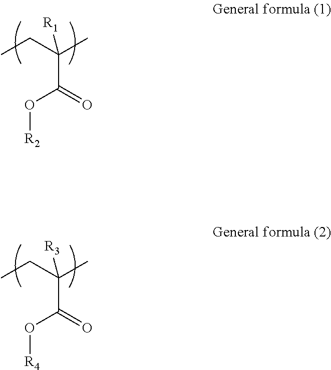

In the general formula (1), R₁ represents a hydrogen atom or a methyl group, and R₂ represents a hydrocarbon group having 6 or more and 12 or less carbon atoms and having an alicyclic structure.

### BRIEF DESCRIPTION OF DRAWINGS

The advantageous and features provided by one or more embodiments of the invention will become more fully understood from the detailed description given hereinbelow and the appended drawing which is given by way of illustration only, and thus are not intended as a definition of the limits of the present invention:
the FIGURE is a schematic configurational view illustrating an example of an image forming apparatus.

### DETAILED DESCRIPTION OF EMBODIMENTS

Hereinafter, one or more embodiments of the present invention will be described with reference to the drawing. However, the scope of the invention is not limited to the disclosed embodiments.

### 1. Electrostatic Charge Image Developing Toner

An embodiment of the present invention relates to an electrostatic charge image developing toner (hereinafter, also simply referred to as “toner”) for developing an electrostatic charge image (electrostatic latent image) formed on an image bearing member such as a photoreceptor. The toner may be a one component developer containing toner base particles or a two component developer containing toner base particles and carrier particles.

### 1-1. Toner Base Particles

The toner base particles contain a binder resin for fixing the toner to a recording medium. The toner base particles may contain a coloring agent and other components inside the particles. Note that the toner may be a color toner in which toner base particles contain a coloring agent, or may be a clear toner in which toner base particles do not contain a coloring agent. In addition, the toner base particles may contain an external additive added as a post-treatment agent on the surface thereof.

### 1-1-1. Binder Resin

The binder resin binds the toner to a recording medium. The binder resin is preferably a thermoplastic resin.

### (Acrylic Polymer)

In the present embodiment, the binder resin includes a polymer having a constituent unit represented by the following general formula (1) and a constituent unit represented by the following general formula (2) (hereinafter, also simply referred to as “acrylic polymer”).

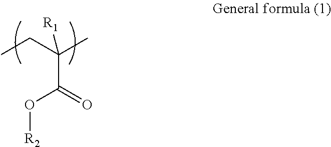

In the general formula (1), R₁ represents a hydrogen atom or a methyl group, and R₂ represents a hydrocarbon group having 6 or more and 12 or less carbon atoms and having an alicyclic structure.

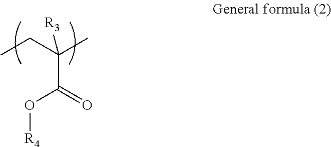

In the general formula (2), R₃ represents a hydrogen atom or a methyl group, and R₄ represents a linear or branched hydrocarbon group having 8 or more and 18 or less carbon atoms.

Note that in the present specification, (meth)acrylic means acrylic or methacrylic; (meth)acrylonitrile means acrylonitrile or methacrylonitrile and (meth)acrylate means acrylate and methacrylate, respectively.

According to the findings of the present inventors, a polymer having an alicyclic structure has a high dielectric loss tangent (tan δ) and is more likely to cause charge leakage. Therefore, the constituent unit having an alicyclic structure represented by general formula (1) can make sticking to other recording media due to charging of an image less likely to occur. On the other hand, a bulky alicyclic structure causes steric repulsion of polymer molecules and reduces entanglement of molecular chains, thereby deteriorating elastic properties of the binder resin. Therefore, a toner containing a polymer having an alicyclic structure is more likely to suffer from hot offset due to a reduction in elastic properties. Further, the constituent unit having an alicyclic structure improves the glass transition temperature (Tg) of the polymer. Therefore, the toner including the polymer having an alicyclic structure is more likely to have low low-temperature fixability.

In contrast, the acrylic polymer used in the present embodiment has high crystallinity due to the long-chain hydrocarbon group contained in the constituent unit represented by general formula (2) as a side chain, and therefore the toner has high low-temperature fixability.

In addition, in the polymer having a long-chain hydrocarbon group in a side chain, the long-chain hydrocarbon groups are oriented to each other to form a crystal having a folded structure, and therefore, the low-temperature fixability of the toner can be enhanced. On the other hand, the long-chain hydrocarbon group decreases the polarity of the polymer or decreases the molecular motion of the polymer due to high crystallization ability, thereby decreasing the dielectric loss tangent (tan δ) of the polymer. Therefore, a toner containing a polymer having a long-chain hydrocarbon group is less prone to charge leakage and tends to stick to another recording medium due to charging of an image. In addition, since a polymer having high crystallinity is less likely to cause molecular motion, it tends to lower the elastic properties of the binder resin. Therefore, a toner containing a polymer having a long-chain hydrocarbon group is more likely to cause hot offset due to a reduction in elastic properties.

In contrast, in the acrylic polymer, the constituent unit represented by general formula (1) partially restricts the crystallization of the hydrocarbon group due to the bulky alicyclic structure. As a result, the acrylic polymer in the toner fixed to the recording medium has a partially crystallized site and a partially uncrystallized site. Therefore, the acrylic polymer has a high dielectric loss tangent (tan δ) although the acrylic polymer has the long-chain hydrocarbon group in the side chain. This makes it possible for the acrylic polymer to facilitate leakage of charges from the binder resin and therefore, the image is less likely to stick to another recording medium due to charging.

In addition, in the acrylic polymer, the main chain of the acrylic polymer is entangled at a site where the acrylic polymer is not crystallized. Furthermore, in the uncrystallized sites, the long-chain hydrocarbon groups in the side chains of the constituent units represented by the general formula (2) are entangled with each other. Due to the entanglement of the molecular chains and the side chains, the acrylic polymer can also enhance the elastic properties of the binder resin to reduce the occurrence of hot offset.

Note that in the case where the toner is a color toner containing a pigment or dye and the elastic properties of the binder resin are reduced due to the constituent unit having an alicyclic structure, the toner is more likely to flow into gaps between fibers of a recording medium (paper), white areas of the paper are more likely to be exposed, and image density unevenness is more likely to occur. On the other hand, since the acrylic polymer used in the present embodiment enhances the elastic properties of the binder resin by the action described above, it is possible to make the image density unevenness less likely to occur in spite of having an alicyclic structure or a long-chain hydrocarbon group in the side chain.

R₁ in general formula (1) represents a hydrogen atom or a methyl group. From the viewpoint of effectively causing partial restriction of crystallization of the hydrocarbon group described above and further suppressing sticking of an image to another recording medium, the constituent unit represented by the general formula (1) preferably includes a constituent unit in which R₁ is a methyl group.

R₂ in the general formula (1) represents a hydrocarbon group having 6 or more and 12 or less carbon atoms and having an alicyclic structure. When the number of carbon atoms of R₂ is within the above range, the effect of suppressing hot offset, the effect of suppressing sticking, and the effect of suppressing image density unevenness due to partial restriction of crystallization can be effectively exhibited. Furthermore, when the number of carbon atoms of R₂ is within the above range, a decrease in the low-temperature fixability of the toner due to the alicyclic structure can be suppressed. Examples of the hydrocarbon group having an alicyclic structure include an isobornyl group, an adamantyl group, a cyclohexyl group, and a dicyclopentanyl group. R₂ preferably has a bulky structure, and specifically preferably has a plurality of cyclic structures, from the viewpoint of efficiently achieving the effects of improving low-temperature fixability, suppressing sticking to other recording media, suppressing hot offset, and suppressing image density unevenness due to the actions described above. For example, R₂ is preferably an isobornyl group or an adamantyl group, and among these, is more preferably an isobornyl group because low-temperature fixability is less likely to decrease.

R₃ in general formula (2) represents a hydrogen atom or a methyl group. From the viewpoint of enhancing the low-temperature fixability of the toner, the constituent unit represented by general formula (2) preferably includes a constituent unit in which R₃ is a hydrogen atom. On the other hand, from the viewpoint of effectively causing partial restriction of crystallization of the hydrocarbon group, suppressing image sticking to other recording media, and making hot offset less likely to occur, the constituent unit represented by the general formula (2) preferably includes a constituent unit in which R₃ is a methyl group. From the viewpoint of achieving a good balance between these, the constituent unit represented by general formula (2) preferably includes both a constituent unit in which R₃ is a methyl group and a constituent unit in which R₃ is a hydrogen atom.

When a constituent unit in which R₃ is a hydrogen atom and a constituent unit in which R₃ is a methyl group are used in combination, R₄ is preferably a linear alkyl group having 8 or more and 12 or less carbon atoms in the constituent unit in which R₃ is a methyl group. In addition, from the viewpoint of enhancing the low-temperature fixability, the ratio of the constituent unit in which R₃ is a methyl group is preferably 1% by mass or more and 50% by mass or less, to the total mass of the constituent units in which R₃ is a hydrogen atom.

R₄ in the general formula (2) represents a linear or branched hydrocarbon group having 8 or more and 18 or less carbon atoms. The number of carbon atoms of R₄ is preferably 8 or more and 12 or less from the viewpoint of enhancing the effect of partial restriction of the crystallization to enhance the elastic properties of the binder resin by the entanglement of the side chains, more effectively suppressing the sticking of the image, and making the hot offset less likely to occur. The value is more preferably 8 or more and 10 or less, and still more preferably 8. From the viewpoint of improving low-temperature fixability, the number of carbon atoms of R₄ is preferably an even number.

In order to further improve the low-temperature fixability of the toner, improve the elastic properties of the binder resin through entanglement of side chains, and reduce the likelihood of hot offset and image density unevenness, the constituent unit represented by the general formula (2) preferably includes a constituent unit in which R₄ is a linear hydrocarbon group. On the other hand, from the viewpoint of effectively causing partial restriction of crystallization and further suppressing the occurrence of image sticking to other recording media, the constituent unit represented by the general formula (2) preferably includes a constituent unit in which R₄ is a branched hydrocarbon group.

Note that the acrylic polymer may have another constituent unit that is different from any of the constituent unit represented by general formula (1) and the constituent unit represented by general formula (2). Examples of the other constituent units include constituent units derived from styrene and derivatives thereof, monomers having a carboxyl group such as (meth)acrylic acid, maleic acid, itaconic acid, and fumaric acid, and (meth)acrylic acid esters. These constituent units can increase the elastic properties of the binder resin by the entanglement of the side chains, thereby making hot offset less likely to occur and image density unevenness less likely to occur. Among these, from the viewpoint of facilitating control of the particle size of the toner base particles and suppressing occurrence of image density unevenness due to an increase in particle size, a constituent unit having a carboxyl group is preferable; and a constituent unit derived from (meth)acrylic acid is more preferable. A constituent unit derived from methacrylic acid is more preferable from the viewpoint of further enhancing elastic properties to make hot offset less likely to occur and to make image density unevenness less likely to occur.

Note that examples of the (meth)acrylic acid ester include methyl (meth)acrylate, ethyl (meth)acrylate, N-butyl (meth)acrylate, isopropyl (meth)acrylate, and isobutyl (meth)acrylate. Also included are tert-butyl (meth)acrylate, N-octyl (meth)acrylate, 2-ethylhexyl (meth)acrylate, stearyl (meth)acrylate, lauryl (meth)acrylate, phenyl (meth)acrylate; dimethylaminoethyl (meth)acrylate, diethylaminoethyl (meth)acrylate, and the like.

In the acrylic polymer, the mass ratio of the constituent unit represented by the general formula (1) to the total mass of the acrylic polymer is preferably 10% by mass or more and 80% by mass or less, more preferably 20% by mass or more and 70% by mass or less. As the mass ratio of the constituent unit represented by general formula (1) is increased, sticking of an image to another recording medium can be made less likely to occur.

In the acrylic polymer, the mass ratio of the constituent unit represented by general formula (2) to the total mass of the acrylic polymer is preferably 5 mass % or more and 75 mass % or less. In addition, the content is more preferably 10 mass % or more and 70 mass % or less. In addition, the content is more preferably 20% by mass or more and 60% by mass or less. As the mass ratio of the constituent unit represented by general formula (2) increases, the low-temperature fixability of the toner can be enhanced. In addition, by adjusting the mass ratio of the constituent unit represented by general formula (1) and the mass ratio of the constituent unit represented by general formula (2), it is also possible to adjust the resistance to hot offset and the resistance to image density unevenness.

Furthermore, in the acrylic polymer, the mass ratio of the other constituent units to the total mass of the acrylic polymer is preferably 1 mass % or more and 80 mass % or less, more preferably 2 mass % or more and 70 mass % or less.

The acrylic polymer preferably has a peak molecular weight in a molecular weight distribution measured by using a refractive-index detector (RI detector) of 3500 or more and 35000 or less, and more preferably has a peak molecular weight of 10000 or more and 30000 or less. When the peak molecular weight is within the above range, the melt viscosity of the acrylic polymer during fixing is more likely to be in an appropriate range, and both the fixability and offset resistance of the toner are more likely to be achieved.

Note that the “peak molecular weight” means a molecular weight corresponding to an elution time of a peak top in a molecular weight distribution. When a plurality of peaks are present in the molecular weight distribution, the molecular weight corresponding to the elution time of the peak top having the largest peak area ratio is defined as the peak molecular weight.

The content of the acrylic polymer is preferably 65 parts by mass or more and 98 parts by mass or less, more preferably 70 parts by mass or more and 95 parts by mass or less, and still more preferably 75 parts by mass or more and 93 parts by mass or less, based on 100 parts by mass of the total amount of the binder resin.

### (Other Binder Resin)

The binder resin may contain a resin other than the acrylic polymer. Examples of other resins include thermoplastic resins such as styrene resins, vinyl resins (e.g., (meth)acrylic resins and styrene-(meth)acrylic resins), polyester resins, silicone resins, olefin resins, polyamide resins, and epoxy resins.

The other resin may be an amorphous resin or may be a crystalline resin. Alternatively, a composite resin in which a crystalline resin and an amorphous resin are hybridized may be used.

Note that in the present specification, the crystalline resin refers to a resin whose melting point is observed when measured by differential scanning calorimetry (DSC). In addition, the amorphous resin means a resin whose melting point is not observed in measurement by DSC. In addition, in the present specification, observation of a melting point in the resin means that a peak whose half width of the endothermic peak is within 15° C. is observed when measured using DSC at a temperature increase rate of 10° C./min.

Examples of other resins include styrene-based polymers. The styrene-based polymers include m-styrene homopolymers, homopolymers of styrene substitutes such as poly-p-chlorostyrene and polyvinyltoluene, and styrenic copolymers such as styrene-p-chlorostyrene copolymers, styrene-vinyltoluene copolymers, styrene-vinylnaphthalene copolymers, styrene-butadiene copolymers and styrene-isoprene copolymers. In addition, examples of other resins include polyvinyl chloride, phenol resins, and vinyl resins such as (meth)acrylic resins. Examples of the vinyl resin also include styrene-(meth)acrylic acid ester copolymers, styrene-α-chloro (meth)acrylic acid methyl copolymers, styrene-(meth)acrylonitrile copolymers, styrene-vinyl methyl ether copolymers, styrene-vinyl ethyl ether copolymers, styrene-vinyl methyl ketone copolymers, and styrene-acrylonitrile-indene copolymers. Examples of the other resins include polyvinyl acetate, silicone resins, polyester resins, polyurethane resins, polyamide resins, furan resins, epoxy resins, xylene resins, polyvinyl butyral, terpene resins, coumarone-indene resins, and natural resins. In addition, examples of other resins include natural modified phenol resins and natural resin-modified maleic acid resins, which are modified natural resins. Furthermore, examples of other resins include other petroleum-based resins. Of these, vinyl resins and polyester resins are preferable, and polyester resins are more preferable, because their polarities are close to that of varnish, and the adhesiveness of varnish is easily improved.

In view of enhancing low-temperature fixability of the toner, the binder resin component preferably includes a crystalline polyester. In addition, the crystalline polyester can also make sticking to another recording medium due to charging of an image less likely to occur.

The crystalline polyester is usually obtained by subjecting a polyvalent carboxylic acid and a polyhydric alcohol to a dehydration condensation reaction by a known method.

The polyvalent carboxylic acid may be a carboxylic acid having a valency of 2 or more, and may be a carboxylic acid having a valency of 3 or more, such as trimellitic acid or pyromellitic acid. Among these, dicarboxylic acids are preferable from the viewpoint of increasing the crystallinity of the crystalline polyester. Examples of the dicarboxylic acid include oxalic acid, malonic acid, succinic acid, glutaric acid, adipic acid, pimelic acid, suberic acid, azelaic acid, and sebacic acid. Also included are 1,9-nonanedicarboxylic acid, 1,10-decanedicarboxylic acid, 1,11-undecanedicarboxylic acid, 1,12-dodecanedicarboxylic acid (dodecanedioic acid), and 1,13-tridecanedicarboxylic acid. Examples of the dicarboxylic acid include aliphatic carboxylic acids such as 1,14-tetradecanedicarboxylic acid, 1,16-hexadecanedicarboxylic acid, and 1,18-octadecanedicarboxylic acid. Examples of the dicarboxylic acids include aromatic dicarboxylic acids such as terephthalic, isophthalic, orthophthalic, t-butylisophthalic, 2,6-naphthalenedicarboxylic, and 4,4′-biphenyldicarboxylic acids. Note that the crystalline polyester may include a constituent unit derived from only one of these carboxylic acids, or may include constituent units derived from two or more of these carboxylic acids.

Among these, an aliphatic carboxylic acid is preferable because the crystallinity of the crystalline polyester is easily increased, and the affinity between the diol di (meth)acrylate that can be contained in the varnish and the crystalline polyester is easily increased. The aliphatic carboxylic acid preferably has a linear hydrocarbon group having 6 or more and 16 or less carbon atoms, and more preferably has a linear hydrocarbon group having 10 or more and 14 or less carbon atoms. The hydrocarbon structure of the aliphatic carboxylic acid may be partially branched.

The polyhydric alcohol may be an alcohol having a valence of 2 or more, and may be an alcohol having a valence of 3 or more, such as glycerin, pentaerythritol, trimethylolpropane, or sorbitol. Of these, dihydric alcohols are preferable from the viewpoint of increasing the crystallinity of the crystalline polyester. Examples of the dihydric alcohol include ethylene glycol, 1,3-propanediol, 1,4-butanediol, and 1,5-pentanediol. In addition, examples of the dihydric alcohol include 1,6-hexanediol, 1,7-heptanediol, 1,8-octanediol, 1,9-nonanediol, 1,10-decanediol, and 1,11-undecanediol. Examples of the dihydric alcohol include aliphatic diols such as 1,12-dodecanediol, 1,13-tridecanediol, 1,14-tetradecanediol, 1,18-octadecanediol, and 1,20-eicosanediol. Furthermore, examples of divalent alcohols include diols having unsaturated double bonds, such as 2-butene-1,4-diol, 3-hexene-1,6-diol, and 4-octene-1,8-diol, and diols having sulfonic acid groups.

From the viewpoint of sufficiently softening the toner base particles to enhance the low-temperature fixability of the toner, the melting point of the crystalline polyester is preferably 50° C. or more and 85° C. or less and more preferably 60° C. or more and 80° C. or less.

The weight-average molecular weight (Mw) of the crystalline polyester is preferably 5000 or more and 50000 or less. The crystalline polyester preferably has a number-average molecular weight (Mn) of 2000 or more and 10,000 or less. When the weight-average molecular weight (Mw) and the number-average molecular weight (Mn) of the crystalline polyester are within the above ranges, the low-temperature fixability becomes satisfactory.

From the viewpoint of sufficiently exhibiting the above-described effect, the content of the crystalline polyester is preferably 5 parts by mass or more and 20 parts by mass or less, more preferably 8 parts by mass or more and 15 parts by mass or less, based on 100 parts by mass of the total amount of the binder resin.

The content of the binder resin is preferably 20% by mass or more and 99% by mass or less, more preferably 30% by mass or more and 95% by mass or less, and even more preferably 40% by mass or more and 90% by mass or less, based on the total mass of the toner base particles. When the content of the binder resin is 20% by mass or more, the strength of an image to be formed can be further increased.

### 1-1-2. Coloring Agent

The coloring agent may be a dye or a pigment. When the toner is a color toner that imparts a predetermined color tone to an image, the toner base particles may contain a coloring agent, such as yellow, magenta, cyan, or black, corresponding to the color tone to be imparted by the color toner. The toner base particles may contain only one coloring agent or a combination of two or more coloring agents.

Examples of the yellow coloring agent include C.I. yellow dyes such as C.I. Solvent Yellow 19, 44, 77, 79, 81, 82, 93, 98, 103, 104, 112, and 162, and the like. Yellow pigments including Pigment Yellow 14, 17, 74, 93, 94, 138, 155, 180, 185, and the like are also included.

Examples of the magenta coloring agent include C.I. magenta dyes such as Solvent Red 1, 49, 52, 58, 63, 111, and 122, and the like. Magenta pigments such as C.I. Pigment Red 5, 48:1, 53:1, 57:1, 122, 139, 144, 149, 166, 177, 178, and 222 are also included.

Examples of the cyan coloring agent include C.I. cyan dyes such as Solvent Blue 25, 36, 60, 70, 93, and 95. Cyan pigments such as C.I. Pigment Blue 1, 7, 15, 15:3, 60, 62, 66, and 76 are also included.

Examples of black coloring agents include carbon blacks such as channel black, furnace black, acetylene black, thermal black, lamp black, and the like. Magnetic materials including ferrite, magnesium, and the like, iron-titanium composite oxides, and the like are also included.

The content of the coloring agent is preferably 0.5 mass % or more and 20 mass % or less, more preferably 2 mass % or more and 10 mass % or less, based on the total mass of the toner base particles. Note that when the toner is a clear toner, the toner base particles preferably do not substantially contain a coloring agent, and the content of the coloring agent is preferably 0.1 mass % or less based on the total mass of the toner base particles.

### 1-1-3. Other Components

The toner base particles may contain other components such as a release agent and a charge control agent.

The release agent enhances releasability of the toner from a fixing member or the like. The release agent is preferably a wax.

Examples of release agents that are waxes include hydrocarbon waxes such as polyethylene waxes, paraffin waxes, microcrystalline waxes, Fischer-Tropsch waxes, and the like. Further, examples of the release agent include dialkyl ketone waxes such as distearyl ketone. Carnauba wax and montan wax are included. Examples of the release agent include behenic acid behenate, trimethylolpropane tribehenate, pentaerythritol tetramyristate, pentaerythritol tetrastearate, pentaerythritol tetrabehenate, pentaerythritol diacetate dibehenate, and glycerin tribehenate. Examples of the release agent also include ester waxes such as 1,18-octadecanediol distearate, tristearyl trimellitate, and distearyl maleate. Further, examples of the release agent include amide waxes such as ethylenediamine dibehenylamide and trimellitic acid tristearylamide.

The hydrocarbon wax preferably has a melting point of 50° C. or more and 95° C. or less. When the melting point of the hydrocarbon wax is 50° C. or higher, the hydrocarbon wax exuding from the toner particles is easily crystallized, and the releasing effect and the abrasion resistance of the formed image are easily enhanced. When the melting point of the hydrocarbon wax is equal to or lower than 95° C., the hydrocarbon wax easily exudes from the toner base particles at the time of fixing, and the releasing effect and the abrasion resistance of the formed image are easily enhanced. In addition, when the melting point of the hydrocarbon wax is 95° C. or less, the toner base particles are readily melted during fixing, and the low-temperature fixability of the toner is readily enhanced.

The content of the release agent is preferably 3% by mass or more and 20% by mass or less and more preferably 5% by mass or more and 15% by mass or less, based on the total mass of the toner base particles. When the content of the release agent is 3% by mass or more, the releasability of the toner from a fixing member is sufficiently enhanced. When the content of the release agent is 20% by mass or less, the toner base particles can contain a sufficient amount of the binder resin, so that the image fixability is sufficiently enhanced.

The charge control agent adjusts the chargeability of the toner base particles.

Examples of the charge control agent include nigrosine dyes, metal salts of naphthenic acid or higher fatty acids, alkoxylated amines, quaternary ammonium salt compounds, azo metal complexes, metal salts of salicylic acid or metal complexes thereof, and the like.

The content of the charge control agent is preferably 0.1% by mass or more and 10% by mass or less, more preferably 0.5% by mass or more and 5% by mass or less, based on the total mass of the binder resin. Note that when an attempt is made to control the chargeability of the toner by a method such as adding an excessive amount of the charge control agent, other properties of the toner base particles may be significantly changed. On the other hand, in the present embodiment, the chargeability of the toner is adjusted by strontium titanate, and thus it is possible to adjust the chargeability of the toner to a desired degree while satisfying other required characteristics.

### 1-1-4. External Additive

The toner base particles may include an external additive that is added as a post-treatment agent to the surfaces of the toner base particles in order to enhance the fluidity, the chargeability, and the cleanability of the toner.

Examples of the external additive include strontium titanate particles, silica particles, alumina particles, zirconia particles, zinc-oxide particles, chromium-oxide particles, and cerium-oxide particles. Furthermore, examples of the external additive include antimony oxide particles, tungsten oxide particles, tin oxide particles, tellurite oxide particles, manganese oxide particles, and boron oxide particles. These particles may be subjected to hydrophobic treatment with a surface treatment agent such as a silane coupling agent or silicone oil, as necessary. Regarding the particle size of these particles, the number-average primary particle size measured in the same manner as for strontium titanate is preferably 20 nm or greater and 200 nm. The particle size is more preferably 30 nm or more and 150 nm or less.

The number average primary particle size of the external additive is determined by binarizing the image data of the external additive captured with a scanning electron microscope (SEM) using an image processing analyzer (LUZEX AP, manufactured by Nireco Corporation). The average value of the Feret diameters in the horizontal direction measured for 100 particles may be used.

Furthermore, the external additive may contain particles containing, as a main component, an organic material including a homopolymer of styrene, methyl methacrylate, or the like, a copolymer thereof, or the like. Regarding these particle size, the particle size of the peak top measured by the same method as that of the strontium titanate is preferably 10 nm or more and 1000 nm.

The external additive may also include a lubricant, such as a metal salt of a higher fatty acid. Examples of the higher fatty acids include stearic, oleic, palmitic, linoleic, and ricinoleic acids. Examples of metals that constitute the above-mentioned metallic salts include Zn, Mn, Al, Fe, Cu, Mg, and Ca.

The content of these external additives is preferably 0.05% by mass or more and 5.0 parts by mass or less based on the total mass of the toner base particles.

### 1-3. Properties of Toner Base Particles

The toner base particles have a volume-based average particle size of preferably 3.0 μm or more and 10.0 μm or less, more preferably 5.0 μm or more and 8.0 μm or less, still more preferably 5.5 μm or more and 7.0 μm or less.

The volume-based average particle size of the toner base particles can be measured by using a measuring apparatus in which a computer system equipped with data processing software is connected to a particle size distribution measuring apparatus. The particle size distribution analyzer used is Coulter Multisizer 3 produced by Beckman Coulter, Inc. Software for data processing was Software V3.51. To be specific, a sample of 0.02 g (toner base particles) is added to and mixed with a surfactant solution of 20 mL, and then subjected to ultrasonic dispersion treatment for 1 minute to prepare a dispersion liquid of toner base particles. The surfactant solution is, for example, a surfactant solution obtained by diluting a neutral detergent containing a surfactant component with pure water by 10 times for the purpose of dispersing the toner base particles. This dispersion liquid is poured into a beaker containing an electrolytic solution (ISOTONII, manufactured by Beckman Coulter, Inc) in a sample stand with a pipette until the concentration displayed on the measurement apparatus reaches 8%. By setting the concentration in this range, a reproducible measurement value can be obtained. Next, in the measurement device, the number of counted measured particles is set to 25000, the aperture diameter is set to 100 μm, the frequency value is calculated by dividing the range of 2 to 60 μm that is the measurement range into 256 parts, and based on this, the volume-based average particle size is calculated.

### 1-4. Method for Producing Toner Base Particles

The toner base particles can be produced in the same manner as known toners by a method such as a pulverization method, an emulsion polymerization aggregation method, an emulsion aggregation method, a suspension polymerization method, or a dissolution suspension method.

Among these, the pulverization method, the emulsion polymerization aggregation method, the emulsion aggregation method, and the suspension polymerization method are preferred, the pulverization method, the emulsion polymerization aggregation method, and the emulsion aggregation method are more preferred, and the emulsion polymerization aggregation method and the emulsion aggregation method are still more preferred.

According to the pulverization method, the toner base particles can be obtained by pulverizing a solid resin composition obtained by melting and kneading a mixture of the binder resins, the release agent, the C16-35 saturated compound, and other materials until a predetermined particle size is obtained.

According to the emulsion polymerization aggregation method, a dispersion liquid of binder resin particles obtained by emulsion polymerization and a dispersion liquid of pigment particles are mixed together with particles of a release agent, a charge control agent, and the like that are optionally added. These are aggregated, associated, or fused until particles having a desired particle size are obtained, and then an external additive is added, thereby obtaining the toner.

According to the emulsion aggregation method, a dispersion liquid of particles of a binder resin obtained by dropping a solution in which the binder resin is dissolved into a poor solvent is mixed with a dispersion liquid of particles of a pigment together with particles such as a release agent and a charge control agent that are optionally added. These are aggregated, associated, or fused until particles having a desired particle size are obtained, and then an external additive is added, thereby obtaining the toner.

Specifically, first, a polymerizable monomer represented by general formula (3) below and a polymerizable monomer represented by general formula (4) below are copolymerized to obtain the acrylic polymer.

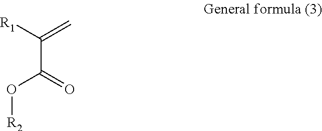

In the general formula (3), R₁ represents a hydrogen atom or a methyl group, and R₂ represents a hydrocarbon group having 6 or more and 12 or less carbon atoms and having an alicyclic structure.

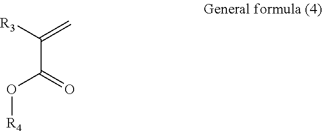

In the general formula (4), R₃ represents a hydrogen atom or a methyl group, and R₄ represents a linear or branched hydrocarbon group having 8 or more and 18 or less carbon atoms.

At this time, a polymerizable monomer that serves as one of the materials of the above-described other constituent units may be copolymerized. The specific type and amount of these polymerizable monomers may be set according to the type and amount of each constituent unit contained in the acrylic polymer described above. In this case, as a chain transfer agent, a mercapto compound such as N-octyl-3-mercaptopropionate may be used in combination.

The acrylic polymer thus obtained may be used to form toner base particles containing the same by each of the methods described above. For example, in an emulsion polymerization aggregation method or an emulsion aggregation method, the dispersion liquid of the acrylic polymer of may be mixed with the dispersion liquid of the crystalline polyester, the dispersion liquid of the coloring agent, or the dispersion liquid of the release agent to aggregate these particles. The dispersion liquid may be a dispersion liquid of resin particles containing any of these.

The toner base particles obtained through the above steps may be used as they are, or may be subjected to external addition treatment with an external additive, as necessary. The external addition treatment with an external additive can be performed by blending predetermined amounts of the toner base particles and the external additive, and stirring and mixing the mixture with a mixing device such as a double-cone mixer, a V-type mixer, a drum mixer, a super mixer, or a Henschel mixer; or a mixing device such as a Nauta mixer, Mechano Hybrid (manufactured by Nippon Coke & Engineering Co., Ltd), or Nobilta (manufactured by Hosokawa Micron Corporation).

### 1-2. Carrier

The carrier is mixed with the toner base particles described above to form the two component magnetic toner. The carrier may be any known magnetic particle that can be contained in toner.

Examples of the magnetic particles include particles containing a magnetic material such as iron, steel, nickel, cobalt, ferrite, and ferromagnetic, and alloys thereof with aluminum, lead, and the like. The carrier may be a coated carrier in which the surface of particles composed of the magnetic material is coated with a resin or the like, or may be a resin-dispersed carrier in which the magnetic material is dispersed in a binder resin. Examples of the coating resin include olefin resins, styrene resins, styrene-acrylic resins, silicone resins, polyester resins, and fluororesins. Examples of the binder resin include acrylic resins, styrene-acrylic resins, polyester resins, fluororesins, and phenol resins.

The carrier has an average particle size of preferably 20 μm or more and 100 μm or less, more preferably 25 μm or more and 80 μm or less in terms of volume-based average particle size. The average particle size of the carrier can be measured by HELOS manufactured by SYMPATEC Co., which is a laser diffraction type particle size distribution measuring apparatus equipped with a wet type dispersing machine.

The content of the carrier is preferably 2% by mass or more and 10% by mass or less based on the total mass of toner base particles and the carrier.

### 2. Image Forming Method and Image Forming Apparatus

Another embodiment of the present invention relates to an image forming apparatus including: a toner image forming section developing an electrostatic latent image with toner to form a toner image; and a fixing device fixing the toner image onto a recording medium by transferring the toner image onto the recording medium. The present invention also relates to an image forming method using the image forming layer. In the present embodiment, the fixing device fixes the above-described toner onto the recording medium.

The image forming apparatus may be a four cycle image forming apparatus including four types of color developing devices of yellow, magenta, cyan, and black, and one electrophotographic photoreceptor. The image forming apparatus may be a tandem-type image forming apparatus including four types of color developing devices of yellow, magenta, cyan, and black, and four electrophotographic photoreceptors provided for the respective colors.

The FIGURE is a schematic configurational view illustrating an example of an image forming apparatus 1 according to the present embodiment. The image forming apparatus 1 illustrated in the FIGURE includes an image processing unit 30, an image forming unit 40, a sheet conveyance section 50, a fixing device 60, and an image reading unit 70.

The image forming portion 40 includes image forming units 41Y, 41M, 41C, and 41K that form images with toners of respective colors of Y (yellow), M (magenta), C (cyan), and K (black). These units have the same configuration except for the toner stored therein, and therefore, hereinafter, the symbol representing the color may be omitted. The image forming section 40 further includes an intermediate transfer unit 42 and a secondary transfer unit 43. These components correspond to a transfer device.

The image forming unit 41 includes an exposure device 411, a developing device 412, an electrophotographic photoreceptor (image bearing member) 413, a charging device 414, and a drum cleaning device 415. The charging device 414 is, for example, a corona charger. The charging device 414 may be a contact charging device that charges the electrophotographic photoreceptor 413 by bringing a contact charging member such as a charging roller, a charging brush, or a charging blade into contact with the electrophotographic photoreceptor 413. The exposure device 411 includes, for example, a semiconductor laser as a light source, and a light deflection device (polygon motor) that irradiates the electrophotographic photoreceptor 413 with laser light corresponding to an image to be formed. The electrophotographic photoreceptor 413 is a negatively chargeable organic photosensitive member having photoconductivity. The electrophotographic photoreceptor 413 is charged by a charging device 414.

The developing device 412 is a developing device of a two component developing method. The developing device 412 includes, for example, a developing container that stores a two component developer, and a developing roller (magnetic roller) that is rotatably disposed at an opening of the developing container. The developing device further includes a partition wall that partitions the inside of the developing container such that the two components in the developer can communicate with each other, a conveyance roller for conveying the two component developer on an opening side in the developing container toward a developing roller, and a stirring roller for stirring the two component developer in the developing container. The developing container stores, for example, two component developer.

The intermediate transfer unit 42 includes an intermediate transfer belt (intermediate transfer member) 421 and primary transfer rollers 422 that bring the intermediate transfer belt 421 into pressure-contact with the electrophotographic photoreceptors 413. The intermediate transfer unit 42 further includes a plurality of support rollers 423 including the backup roller 423A, and a belt cleaning device 426. The intermediate transfer belt 421 is stretched in a loop around the plurality of support rollers 423. The rotation of at least one drive roller of the plurality of support rollers 423 causes the intermediate transfer belt 421 to run in the arrow direction A at a constant speed.

The belt cleaning device 426 includes an elastic member 426a. The elastic member 426a comes into contact with the intermediate transfer belt 421 after the secondary transfer to remove the adhered substance on the surface of the intermediate transfer belt 421. The elastic member 426a is formed of an elastic body, and includes a cleaning blade, a brush, or the like.

The secondary transfer unit 43 includes an endless secondary transfer belt 432 and a plurality of support rollers 431 including a secondary transfer roller 431A. The secondary transfer belt 432 is stretched in a loop by the secondary transfer roller 431A and the support rollers 431.

The fixing device 60 includes, for example, a fixing roller 62 and an endless heating belt 10 that covers an outer circumferential surface of the fixing roller 62 and heats and melts the toner constituting the toner image on the sheet S. The fixing device further includes a pressure roller 63 that presses the sheet S toward the fixing roller 62 and the heating belt 10. The sheet S corresponds to a recording medium.

The image forming apparatus 1 further includes an image reading section 70, an image processing section 30, and a sheet conveyance section 50. The image reading section 70 includes a sheet feed device 71 and a scanner 72. The sheet conveyance section 50 includes a sheet feed section 51, a sheet ejection section 52, and a conveyance path section 53. Each of sheet S identified based on a basis weight, a size, and the like is stored per preset paper type (a standard sheet or a special sheet) in each of the three respective sheet feed tray units 51a to 51c constituting the sheet feed section 51. The conveyance path section 53 includes a plurality of conveyance roller pairs such as a registration roller pair 53a.

Formation of an image by the image forming apparatus 1 will be described.

The scanner 72 optically scans and reads the document D on the exposure glass. Reflected light from the document D is read by the CCD sensor 72a and becomes input image data. The input image data undergoes predetermined image processing in the image processing section 30 and is sent to the exposure device 411.

The electrophotographic photoreceptor 413 rotates at a constant circumferential speed. The charging device 414 uniformly and negatively charges the surface of the electrophotographic photoreceptor 413. In the exposure device 411, the polygon mirror of the polygon motor rotates at a high speed, and the laser light corresponding to the input image data of each color component spreads along the axial direction of the electrophotographic photoreceptor 413 and is emitted onto the outer circumferential surface of the electrophotographic photoreceptor 413 along the axial direction. Thus, an electrostatic latent image is formed on the surface of the electrophotographic photoreceptor 413.

In the developing device 412, the toner base particles are charged by stirring and conveying the two component developer in the developing container, and the two component developer is conveyed to the developing roller to form a magnetic brush on the surface of the developing roller. The charged toner base particles are electrostatically adhered to a portion of the electrostatic latent image on the electrophotographic photoreceptor 413 from the magnetic brush. Thus, the electrostatic latent image on the surface of the electrophotographic photoreceptor 413 is visualized, and a toner image corresponding to the electrostatic latent image is formed on the surface of the electrophotographic photoreceptor 413. Note that the term “toner image” refers to a state in which toner is aggregated into an image shape.

The toner image on the surface of the electrophotographic photoreceptor 413 is transferred to the intermediate transfer belt 421 by the intermediate transfer unit 42. The transfer residual toner remaining on the surface of the electrophotographic photoreceptor 413 after transfer is removed by the drum cleaning device 415 including a drum cleaning blade that comes in sliding contact with the surface of the electrophotographic photoreceptor 413.

The intermediate transfer belt 421 is pressed against the electrophotographic photoreceptor 413 by the primary transfer roller 422, so that a primary transfer nip is formed for each electrophotographic photoreceptor by the electrophotographic photoreceptor 413 and the intermediate transfer belt 421. At the primary transfer nips, the toner images in respective colors are sequentially transferred onto the intermediate transfer belt 421 in a superimposed manner.

On the other hand, the secondary transfer roller 431A is pressed against the backup roller 423A via the intermediate transfer belt 421 and the secondary transfer belt 432. Thus, a secondary transfer nip is formed by the intermediate transfer belt 421 and the secondary transfer belt 432. A sheet S passes through the secondary transfer nip. The sheet S is conveyed to the secondary transfer nip (adhesion section) by the sheet conveyance section 50. The correction of the inclination of the sheet S and the adjustment of the conveyance timing are performed by a registration roller section in which a registration roller pair 53a is arranged.

When the sheet S is conveyed to the secondary transfer nip, a transfer bias is applied to the secondary transfer roller 431A. By the application of the transfer bias, the toner image carried on the intermediate transfer belt 421 is transferred onto the sheet S (step of adhering the electrostatic charge image developing toner to the recording medium). The sheet S on which the toner image has been transferred is conveyed toward the fixing device 60 by the secondary transfer belt 432.

Adhered substances such as transfer residual toner remaining on the surface of the intermediate transfer belt 421 after the secondary transfer are removed by a belt cleaning device 426 having a cleaning blade to be brought into sliding contact with the surface of the intermediate transfer belt 421. At this time, since the above-described intermediate transfer member is used as the intermediate transfer belt, the dynamic frictional force can be reduced with time.

The fixing device 60 forms a fixing nip by sandwiching the heating belt 10 between the rotating fixing roller 62 and the pressure roller 63, and heats and pressurizes the conveyed sheet S at the fixing nip portion. In this way, the toner image is fixed to the sheet S (step of fixing electrostatic charge image developing toner to recording medium). The sheet S carrying a fixed toner image is ejected to the outside of the apparatus by the sheet ejection section 52 including sheet ejection rollers 52a.

Note that the above-described apparatus configuration and image forming method are merely exemplary modes for carrying out the present invention, and the present invention is not limited thereto.

### EXAMPLE

Hereinafter, the present invention will be described in more detail with reference to Examples, but the present invention is not limited thereto.

In the following Examples, unless otherwise specified, the average particle size of each particle is a volume-based average particle size measured using Coulter Multisizer 3 manufactured by Beckman Coulter, Inc.

### 1. Production of Electrostatic Charge Image Developing Toner

### 1-1. Preparation of Toner 1

### 1-1-1. Preparation of Dispersion Liquid of Acrylic Polymer Particles

A stainless steel vessel (SUS vessel) of 5 L equipped with a stirrer, a thermometer, a cooling tube, and a nitrogen-introducing device was charged with sodium dodecylsulfate 8 g dissolved in ion-exchanged 3 L. Under a nitrogen stream, the liquid temperature was increased to 80° C. while stirring at a stirring speed of 230 rpm.

The temperature after the addition was set to 80° C., and a monomer mixture liquid having the following composition was further added dropwise over 100 minutes. The initiator liquid was prepared by dissolving potassium persulfate (10 g) in ion-exchanged water (200 g).

### —Monomer Mixed Liquid—

Polymerizable monomer represented by general formula (3): Isobomyl acrylate (IBXA) 568 g
Polymerizable monomer represented by general formula (4): n-Octyl acrylate (OA) 184 g
Other monomers: Methacrylic acid (MAA) 48 g
Polymerization initiator: n-Octyl-3-mercaptopropionate 5.5 g

The system to which the monomer mixture had been added dropwise was heated and stirred for 2 hours while maintaining the temperature at 80° C. to react the polymerizable monomers, thereby preparing a dispersion liquid of acrylic polymer particles.

The volume-based median size (d50) of the acrylic polymer particles contained in the obtained dispersion liquid of acrylic polymer particles was measured by a dynamic light scattering method using “Microtrac UPA-150” (manufactured by Nikkiso Co., Ltd) and found to be 115 nm.

Furthermore, the peak molecular weight of the acrylic polymer was measured by the following method and found to be 21100.

An apparatus “HLC-8220” (manufactured by Tosoh Corporation) and a column “TSK guard column+TSK gel Super HZM-M 3 series” (manufactured by Tosoh Corporation) were used. While the column temperature was maintained at 40° C., tetrahydrofuran (THF) was allowed to flow as a carrier-solvent at a flow rate of 0.2 ml/min, the solvent temperature was set to room temperature (25° C.), and an ultrasonic treatment was performed for 5 minutes using an ultrasonic disperser. Thus, a tetrahydrofuran solvent of an acrylic polymer having a concentration of 1 mg/ml was obtained.

This solution was treated with a membrane filter having a pore size of 0.2 μm to obtain a sample solution. 10 μl of the sample solution was injected into the apparatus together with the carrier solvent, and the molecular weight distribution of the acrylic polymer was measured using a refractive index detector (RI detector). The peak molecular weight in the measured molecular weight distribution was determined.

### 1-1-2. Preparation of Dispersion Liquid of Coloring Agent Particles

The following materials were prepared.
Coloring agent: 10 parts by mass
Surfactant: 1.5 parts by mass
Ion exchange water: 90 parts by mass

As the coloring agent, carbon black (Mogul®, manufactured by L Cabot Corporation) was used. As the surfactant, a 20% by mass aqueous solution of sodium dodecylbenzenesulfonate was used.

The above materials were mixed and dispersed by an SC mill to obtain dispersion liquid 1 of coloring agent particles. The volume-based median size (d50) of the coloring agent particles contained in the obtained dispersion liquid of the coloring agent particles was measured by a dynamic light scattering method using “Microtrac UPA-150” (manufactured by Nikkiso Co., Ltd), and it was 155 nm.

1-1-3. Preparation of Dispersion liquid of Release Agent Particles

The following materials were prepared.
Mold release agent (behenyl behenate): 100 parts by mass
Surfactant (sodium dodecyl sulfate): 5 parts by mass
Ion exchange water: 240 parts by mass

The above materials were subjected to a dispersion liquid treatment for 10 minutes in a round-shaped flask made of stainless steel using a homogeniser “Ultra-Turrax® T50” (manufactured by IKA Works, Inc), and then further subjected to a dispersion liquid treatment using a pressure-discharge type homogeniser to obtain a dispersion liquid of release agent particles. The volume-based median size (d50) of the release agent particles in the obtained release agent dispersion liquid was measured by a laser diffraction particle size distribution analyzer LA-750 (manufactured by Horiba, Ltd) and found to be 530 nm.

### 1-1-4. Preparation of Dispersion Liquid of Crystalline Polyester Resin Particles

Into a reactor equipped with a stirrer, a thermometer, a cooling tube, and a nitrogen inlet tube, 281 parts by mass of dodecanedioic acid and 107 parts by mass of 1,4-butanediol were charged. The atmosphere in the reaction vessel was replaced with dry nitrogen gas, 0.1 parts by mass of Ti (O-n-Bu)₄ was added, and the obtained mixed liquid was stirred under a nitrogen gas stream for 8 hours while the temperature of the mixed liquid was raised to about 180° C. to react the materials. Furthermore, 0.2 parts by mass of Ti (O-n-Bu)₄ was added to the mixed liquid, the temperature of the mixed liquid was raised to about 220° C. and the mixed liquid was stirred for 6 hours, and then a reaction was allowed to proceed until the acid number measured according to JIS K0070:1992 became 20 mgKOH/g. Thereafter, the pressure in the reactor was reduced to 1333.2 Pa, and the reaction was further allowed to proceed under reduced pressure. The acid number measured according to JIS K0070:1992 of the obtained crystal polyester resins was 20 mgKOH/g, the number-average molecular weight (Mn) was 5,500, the weight-average molecular weight (Mw) was 18,000, and the melting temperature (Tm) was 72° C.

30 parts by mass of the obtained crystalline polyester resins were heated and melted, and transferred to an emulsifying disperser “CAVITRON CD1010” (manufactured by Eurotec Co., Ltd) at a transfer rate of 100 parts by mass per minute. At the same time, 120 parts by mass of diluted ammonia water (concentration 0.37% by mass) was transferred to the emulsifying disperser at a transfer rate of 0.1 Ls per minute while being heated to 100° C. by a heat exchanger. Note that the diluted ammonia water was prepared by diluting 70 parts by mass of reagent ammonia water with ion exchanged water in a water-based solvent tank.

The emulsification disperser was then subjected to an operation at a rotor rotation speed of 60 Hz and pressures of 5 kg/cm² (490 kPa) to obtain 30 parts by mass of a dispersion liquid of crystalline polyester particles (solids concentration: 20% by weight). The volume-based median size (d50) of the crystalline polyester resin particles in the obtained dispersion liquid of crystalline polyester resin particles was measured using a Microtrac particle size distribution analyzer “UPA-150” (manufactured by Nikkiso Co., Ltd) and found to be 200 nm.

### 1-1-5. Preparation of Dispersion Liquid of Toner Base Particles

The following materials were prepared.
Dispersion of acrylic polymer particles: 237 parts by mass
Dispersion Liquid of Coloring Agent Particles: 42 parts by mass
Dispersion of release agent particles: 18 parts by mass
Polyaluminum chloride: 1.8 parts by mass
Ion exchange water: 600 parts by mass

The above materials were mixed and dispersed in a round-bottom stainless-steel flask with a homogeniser “Ultra-Turrax® T50” (manufactured by IKA). Thereafter, the temperature was increased to 55° C. while stirring the inside of the flask in a heating oil bath. After the temperature rise, 60 parts by mass (in terms of solid content) of the dispersion liquid of crystalline polyester resin particles was added to the mixed liquid over 10 minutes to allow aggregation of the particles to proceed. Further holding at 55° C. for 30 minutes, and then, it was confirmed that aggregated particles having a volume-based median size (D50) of 4.8 μm were formed in the dispersion liquid. When the temperature of the heating oil bath was further raised and maintained at 56° C. for 2 hours, the volume-based median diameter (D50) became 5.9 μm.

Thereafter, sodium hydroxide (1 mol/L) was added to the system to adjust the pH level of the system at 56° C. to 5.0, and the round stainless steel flask was sealed with a magnetic seal and heated to 98° C. while stirring was continued. The mixture was continuously stirred for 6 hours to complete fusion between the binder resin particles, thereby preparing a dispersion liquid of toner base particles. The volume-based median size (D50) of the toner base particles in the dispersion liquid was 6.1 μm.

The obtained dispersion liquid of the toner base particles was subjected to solid-liquid separation with a basket-type centrifuge “MARK III, model number 60×40” (manufactured by Matsumoto Kikai Co., Ltd) to obtain a wetcake of the toner base particles.

The obtained wet cake was washed with ion-exchanged water at 45° C. by the basket type centrifugal separator until the electric conductivity of the filtrate became 5 μS/cm. Thereafter, the resultant was transferred to “Flash Jet Dryer” (manufactured by Seishin Enterprise Co., Ltd) and dried until the moisture amount became 0.5% by mass, thereby obtaining toner base particles 1.

1-1-6. Treatment with External Additive

To 100 parts by mass of the obtained toner base particles 1, 1 part by mass of hydrophobic silica (number-average primary particle size: 12 nm) and 0.3 parts by mass of hydrophobic titania (number-average primary particle size: 20 nm) were added. An external additive treatment was performed by mixing with a Henschel Mixer® to produce a toner 1.

### 1-2. Preparation of Toner 2 to Toner 26

Toner 2 to toner 26 were obtained in the same manner as in the production of toner 1, except that the type and amount of the polymerizable monomer to be added in the preparation of the dispersion liquid of binder resin particles were changed as listed in Table 1.

### 1-3. Preparation of Toner 27

Toner 27 was obtained in the same manner as in the production of toner 1 except that the dispersion liquid of crystalline polyester resin particles was not added in the preparation of the dispersion liquid of toner base particles.

### 1-4. Preparation of Toner 28 and Toner 29

Toner 28 and toner 29 were obtained in the same manner as in the production of toner 1, except that the type and amount of the polymerizable monomer to be added in the preparation of the dispersion liquid of binder resin particles were changed as listed in Table 1.

Table 1 shows the types and the amounts (percentages by weight relative to the total amount of monomers) of the polymerizable monomer represented by general formula (3), the polymerizable monomer represented by general formula (4), and the other polymerizable monomers used in the production of toner 1 to toner 29. Also, the presence or absence of addition of crystalline polyester (CPEs), and the peak molecular weight are indicated.

TABLE 1

| | Acrylic polymer | | | | | | | | | | |
|---|---|---|---|---|---|---|---|---|---|---|---|
| | General | | General | | General formula | | Others | | | | |
| Toner | formula (3) | | formula (4)-1 | | (4)-2 | | St | MAA | AA | BA | |
| No | Type | Amount | Type | Amount | Type | Amount | Amount | Amount | Amount | Amount | CPEs |
| 1 | IBXA | 71 | OA | 23 | — | — | — | 6 | — | — | ○ |
| 2 | IBXA | 50 | OA | 24 | — | — | 20 | 6 | — | — | ○ |
| 3 | IBXA | 30 | OA | 23 | — | — | 41 | 6 | — | — | ○ |
| 4 | IBXA | 10 | OA | 24 | — | — | 60 | 6 | — | — | ○ |
| 5 | IBXA | 30 | OA | 21 | — | — | 47 | — | 2 | — | ○ |
| 6 | IBXA | 30 | — | — | OMA | 38 | 26 | 6 | — | — | ○ |
| 7 | IBXA | 30 | OA | 18 | OMA | 9 | 37 | 6 | — | — | ○ |
| 8 | IBXA | 21 | OA | 23 | — | — | 50 | 6 | — | — | ○ |
| 9 | IBXA | 30 | DA | 30 | — | — | 33 | 7 | — | — | ○ |
| 10 | IBXA | 30 | DDA | 50 | — | — | 14 | 6 | — | — | ○ |
| 11 | IBXMA | 61 | OA | 33 | — | — | — | 6 | — | — | ○ |
| 12 | IBXMA | 51 | OA | 33 | — | — | 10 | 6 | — | — | ○ |
| 13 | IBXMA | 30 | OA | 30 | — | — | 34 | 6 | — | — | ○ |
| 14 | IBXMA | 10 | OA | 26 | — | — | 58 | 6 | — | — | ○ |
| 15 | IBXMA | 30 | OA | 28 | — | — | 40 | — | 2 | — | ○ |
| 16 | IBXMA | 30 | — | — | OMA | 47 | 17 | 6 | — | — | ○ |
| 17 | IBXMA | 30 | OA | 22 | OMA | 11 | 31 | 6 | — | — | ○ |
| 18 | IBXMA | 21 | OA | 28 | — | — | 45 | 6 | — | — | ○ |
| 19 | IBXMA | 30 | DA | 30 | — | — | 33 | 7 | — | — | ○ |
| 20 | IBXMA | 30 | DDA | 60 | — | — | 4 | 6 | — | — | ○ |
| 21 | ADMA | 30 | OA | 30 | — | — | 33 | 7 | — | — | ○ |
| 22 | ADMMA | 30 | OA | 35 | — | — | 29 | 6 | — | — | ○ |
| 23 | CHA | 30 | OA | 13 | — | — | 51 | 6 | — | — | ○ |
| 24 | CHMA | 30 | OA | 20 | — | — | 44 | 6 | — | — | ○ |
| 25 | IBXMA | 30 | 2EHA | 29 | — | — | 35 | 6 | — | — | ○ |
| 26 | IBXMA | 20 | ODA | 74 | — | — | — | 6 | — | — | ○ |
| 27 | IBXA | 71 | OA | 23 | — | — | — | 6 | — | — | × |
| 28 | IBXMA | 30 | — | — | — | — | 38 | 6 | — | 26 | ○ |
| 29 | — | — | OA | 23 | — | — | 71 | 6 | — | — | ○ |

The abbreviations of the polymerizable monomers described in Table 1 respectively indicate the compounds shown in Table 2.

TABLE 2

| | Abbreviation | Compound name |
|---|---|---|
| Polymer monomer | IBXA | Isobornyl acrylate |
| represented by general | IBXMA | Isobornyl methacrylate |
| formula (3) | ADMA | Adamantyl acrylate |
| | ADMMA | Adamantyl methacrylate |
| | CHA | Cyclohexyl acrylate |
| | CHMA | Cyclohexyl methacrylate |
| Polymer monomer-1 | OA | n-Octyl acrylate |
| represented by general | DA | n-Decyl acrylate |
| formula (4) (Acrylate) | DDA | n-Dodecyl acrylate |
| | 2EHA | 2-Ethylhexyl acrylate |
| | ODA | n-Octadecyl acrylate |
| Polymer monomer-2 | OMA | n-Octyl methacrylate |
| represented by general | | |
| formula (4) (Methacrylate) | | |
| Other | St | Styrene |
| polymerizable monomers | MAA | Methacrylic acid |
| | AA | Acrylic acid |
| | BA | n-Butyl acrylate |

### 2. Evaluation

The toners 1 to 29 were evaluated for low-temperature fixability, adhesive strength, hot offset resistance, and image density unevenness by the following methods.

### 2-1. Low-Temperature Fixability

The developing device of a commercially available color multifunction peripheral “bizhub PRO C6500 (manufactured by Konica Minolta Business Technologies Inc)” was modified so that the fixing temperature, the toner adhesion amount, and the system speed could be freely set.

A solid image having a toner adhesion amount of 11.3 g/m² was formed on “NPI 128 g/m² (manufactured by Nippon Paper Industries Co., Ltd)” used as evaluation paper in a normal-temperature and normal-humidity (temperature: 20° C., humidity: 50% RH) environment. The fixing speed was 300 mm/see, the temperature of the upper fixing belt was increased from 110° C. to 200° C. in increments of 5° C., the temperature of the lower fixing roller was set to 100° C., and the layers were sequentially formed.

The temperature of the fixing upper belt at which under offset did not occur during sequential formation of images was defined as the lower limit fixing temperature. Based on the lower limit fixing temperature, the low-temperature fixability of each toner was evaluated according to the following criteria.
A: The lower limit fixing temperature was less than 145° C.
B: The lower limit fixing temperature was 145° C. or more and less than 150° C.
C: The lower limit fixing temperature was 150° C. or more and less than 155° C.
D: The lower limit fixing temperature was equal to or higher than 155° C.

### 2-2. Adhesive Strength

A solid image having a toner adhesion amount of 8.0 g/m² was formed on A3 size paper (“OK Top Coat Paper: 157 g/m², manufactured by Oji Paper Co., Ltd) used as evaluation paper in a normal-temperature and normal-humidity environment (temperature: 20° C., humidity: 50% RH) using a commercially available color multifunction peripheral “bizhub PRESS C107 (manufactured by Konica Minolta Inc)”. The lower roller temperature was set to 70° C., and five sheets were output in a double-sided output mode. 500 sheet of evaluation paper on which an image was not formed was placed on the output paper bundle and left for 2 hours. sheetsheetsheetsheetThereafter, the evaluation paper on which no image was formed was removed, the five evaluation papers on which images were formed were placed on a flat table, a tape was attached to the tip of the uppermost evaluation paper, and the force required for slowly sliding the evaluation paper in the horizontal direction was measured with a spring scale. The evaluation sheets below the second sheet from the top were fixed to the table so as not to move.

This measurement was repeated four times in order from the top evaluation paper, and the average value of the force [N] indicated by the spring scale was taken as the adhesive strength. Note that a toner having an adhesive strength of 2.0 N or less was determined to be usable.

### 2-3. Hot Offset Resistance

The developing device of a commercially available color multifunctional machine “bizhub PRO C6500 (manufactured by Konica Minolta Business Technologies, Inc)” was modified so that the fixing temperature could be freely set.

A solid image having an image density of 0.8 was formed on thick paper having a basis weight of 128 g/m² used as the evaluation paper under an environment of normal-temperature and normal-humidity (temperature of 20° C. and humidity of 50% RH). The temperature of the upper fixing belt and the lower fixing roller was increased from 120° C. to 220° C. in increments of 10° C., and the layers were sequentially formed.

The hot offset resistance of each toner was evaluated according to the following criteria, based on the fixing temperature at which hot offset started to occur during sequential formation of images.
A: Hot offset did not occur even at a fixing temperature of 150° C.
B: Hot offset has occurred at a fixing temperature of 150° C.
C: Hot offset has occurred at a fixing temperature of 140° C.
D: Hot offset has occurred at a fixing temperature of 130° C.
E: Hot offset has occurred at a fixing temperature of less than 130° C.

### 2-4. Image Density Unevenness

The developing device of a commercially available color multifunction peripheral “bizhub PRESS C1100 (manufactured by Konica Minolta Inc)” was modified so that the surface temperature of the upper fixing belt could be changed in the range of 140 to 220° C.

Under a normal-temperature and normal-humidity (temperature: 20° C., humidity: 50% RH) environment, a solid image having a toner adhesion amount of 8.0 g/m² was formed on rough paper “Hammermill tidal (manufactured by Hammermill)” used as evaluation paper. The fixing speed was set to 460 mm/see, and the temperature of the fixing upper belt was set to a temperature higher by 15° C. than the temperature of the fixing upper belt at which under-offset did not occur.

The density unevenness of the formed solid image was visually observed by trained panelists, and the low-temperature fixability of each toner was evaluated according to the following criteria.
A: No density unevenness is confirmed
B: Slight density unevenness is confirmed, but it is determined that there is no problem with quality
C: Density unevenness is clearly confirmed in a part of the image, but determined to be usable
D: Density unevenness is confirmed in the entire image and determined to be unusable

Table 3 shows the evaluation results. Note that Table 3 also shows the peak molecular weight of the acrylic polymer measured at the time of production of each toner.

TABLE 3

| | | Evaluation | | | | Peak |
|---|---|---|---|---|---|---|
| | | Low- | Adhesive | Hot | Image | molec- |
| | Toner | temperature | strength | offset | density | ular |
| Remarks | No | fixability | [N] | resistance | unevenness | weight |
| Example | 1 | B | 1.4 | A | A | 20200 |
| Example | 2 | B | 1.5 | A | A | 21400 |
| Example | 3 | A | 1.6 | A | A | 21350 |
| Example | 4 | A | 1.5 | B | B | 22400 |
| Example | 5 | A | 1.8 | B | B | 20400 |
| Example | 6 | B | 1.5 | A | A | 19384 |
| Example | 7 | A | 1.3 | A | A | 19378 |
| Example | 8 | A | 1.6 | B | A | 21600 |
| Example | 9 | A | 1.7 | A | A | 19670 |
| Example | 10 | A | 1.9 | B | B | 19100 |
| Example | 11 | B | 1.3 | A | A | 21300 |
| Example | 12 | B | 1.4 | A | A | 21690 |
| Example | 13 | A | 1.5 | A | A | 21310 |
| Example | 14 | A | 1.8 | B | B | 22250 |
| Example | 15 | A | 1.7 | B | B | 21130 |
| Example | 16 | B | 1.6 | A | A | 19876 |
| Example | 17 | A | 1.3 | A | A | 19654 |
| Example | 18 | A | 1.5 | B | A | 20300 |
| Example | 19 | A | 1.6 | B | B | 19400 |
| Example | 20 | A | 1.8 | B | B | 18950 |
| Example | 21 | B | 1.3 | A | A | 19700 |
| Example | 22 | B | 1.2 | A | A | 19320 |
| Example | 23 | C | 1.8 | B | B | 21220 |
| Example | 24 | B | 1.7 | B | B | 21780 |
| Example | 25 | B | 1.3 | C | B | 18960 |
| Example | 26 | A | 2 | C | C | 18655 |
| Example | 27 | C | 1.2 | A | A | 20100 |
| Com- | 28 | D | 1.1 | D | C | 19200 |
| parative | | | | | | |
| example | | | | | | |
| Com- | 29 | A | 2.3 | E | D | 19200 |
| parative | | | | | | |
| example | | | | | | |

As is clear from Table 3, toners each containing the acrylic polymer having a constituent unit represented by general formula (1) and a constituent unit represented by general formula (2) was able to achieve all of the low-temperature fixability, the suppression of sticking to other recording media, and the resistance to hot offset.

### INDUSTRIAL APPLICABILITY

According to the present invention, there is provided a toner that can form an image that is less likely to stick to other recording media, has excellent low-temperature fixability, and is less likely to cause hot offset.

### REFERENCE SIGNS LIST

1 Image forming apparatus
10 Heating belt
30 Image processing section
40 Image forming section
41Y, 41M, 41C, 41K Image forming unit
42 Intermediate transfer unit
43 Secondary transfer unit
50 Sheet conveyance section
51 Sheet feed section
51A, 51B, 51C Sheet feed tray unit
52 Sheet ejection section
52A Sheet ejection roller
53 Conveyance path section
53a Registration roller pair
60 Fixing device
62 Fixing roller
63 Pressure roller
70 Image reading section
71 Sheet feed device
72 SCANNER
72A CCD Sensor
411 Exposure device
412 Developing device
413 Electrophotographic photoreceptor
414 Charging device
415 Drum cleaning device
421 Intermediate transfer belt
422 Primary transfer roller
423, 431 Support roller
423A Backup roller
426 Belt cleaning device
426A Elastic member
431A Secondary transfer roller
432 Secondary transfer belt
D Document
S Sheet

Although embodiments of the present invention have been described and illustrated in detail, the disclosed embodiments are made for purposes of illustration and example only and not limitation. The scope of the present invention should be interpreted by terms of the appended claims.

What is claimed is:

1. A toner for developing an electrostatic charge image, the toner comprising a binder resin in a toner base particle of the toner, wherein
the binder resin includes a polymer having a constituent unit represented by general formula (1) below and a constituent unit represented by general formula (2) below: 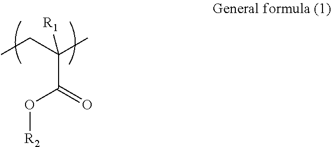
wherein, R₁ represents a hydrogen atom or a methyl group, and R₂ represents a hydrocarbon group having 6 or more and 12 or less carbon atoms and having an alicyclic structure, and 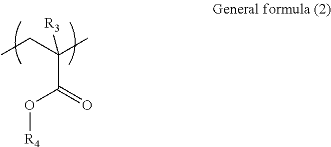
wherein, R₃ represents a hydrogen atom or a methyl group, and R₄ represents a linear or branched hydrocarbon group having 8 or more and 18 or less carbon atoms.

2. The toner according to claim 1, wherein
the toner base particle includes a coloring agent.

3. The toner according to claim 1, wherein
the polymer has another constituent unit different from both the constituent unit represented by the general formula (1) and the constituent unit represented by the general formula (2).

4. The toner according to claim 3, wherein
the other constituent unit has a constituent unit derived from a polymerizable monomer selected from the group consisting of styrene, (meth)acrylic acid, and (meth)acrylic acid esters.

5. The toner according to claim 3, wherein
the other constituent unit has a constituent unit derived from (meth)acrylic acid.

6. A method for producing a toner for developing an electrostatic charge image, the method comprising:
obtaining a polymer by copolymerizing a polymerizable monomer represented by general formula (3) below and a polymerizable monomer represented by general formula (4) below: 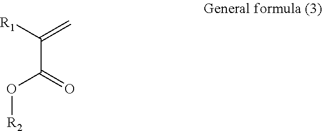
wherein, R₁ represents a hydrogen atom or a methyl group, and R₂ represents a hydrocarbon group having 6 or more and 12 or less carbon atoms and having an alicyclic structure, and 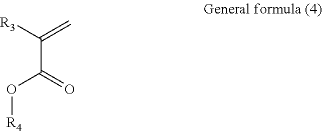
wherein, R₃ represents a hydrogen atom or a methyl group, and R₄ represents a linear or branched hydrocarbon group having 8 or more and 18 or less carbon atoms; and
forming a toner particle including the obtained polymer.

7. The method according to claim 6, wherein
the toner particle formed in the forming of the toner particle includes the polymer and a coloring agent.

8. The method according to claim 6, wherein:
the obtaining of the polymer includes obtaining a dispersion liquid of the polymer; and
the forming of the toner particle includes mixing the dispersion liquid of the polymer.

9. An image forming method, comprising:
adhering the toner according to claim 1 to a recording medium; and
fixing the adhered toner to the recording medium.

10. An image forming apparatus, comprising:
an adhesion section that adheres the toner according to claim 1 to a recording medium; and
a fixer that fixes the adhered toner to the recording medium.
